(19) United States
(12) Patent Application Publication
(10) Pub. No.: US 2007/0241157 A1
(43) Pub. Date: Oct. 18, 2007

(54) All terrain vehicle (ATV) cargo bag construction

(75) Inventors: Donald E. Godshaw, Evanston, IL (US); Andrezj M. Redzisz, Wheeling, IL (US); Hai Du, Mount Prospect, IL (US)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Elk Grove Village, IL (US)

(21) Appl. No.: 11/409,140

(22) Filed: Apr. 21, 2006

Related U.S. Application Data
(63) Continuation-in-part of application No. 11/404,351, filed on Apr. 14, 2006.

(51) Int. Cl. B60R 9/00; B60R 11/00; A45C 15/00

(52) U.S. Cl. 224/583; 224/584; 224/401; 224/546

(57) ABSTRACT

An all terrain vehicle cargo bag assembly includes two or more separate sections which are connectable one to the other or detachable and which enable the inclusion of specially designed inserts in the combination for purposes of transport of various items. The assembly typically includes a central section and first and second lateral side sections attachable to the central section by means of hook and loop fastener straps. A protective flap on one side of the central section covers the connecting straps and also serves as a backrest when the luggage assembly is attached to an all terrain vehicle and appropriately positioned relative to the seat of the vehicle.

### BACKGROUND OF THE INVENTION

In a principal aspect the present invention relates to an all terrain vehicle cargo bag assembly or construction comprised of multiple sections which are attachable one to the other and which, in combination, may be attached to an all terrain vehicle (ATV) in a manner enabling the assembly for not only storage, but also as a back support for the seat of the all terrain vehicle.

All terrain vehicles typically are four wheel vehicles capable of transport off of paved roads and even in areas where there are no trails. Typically such vehicles are four wheel drive vehicles capable of transport of a single person or two persons, one behind the other. The engine for the vehicle is generally positioned along a middle section of the vehicle with a seat positioned generally over the engine and a steering mechanism for the front wheels of the vehicle with handlebars or a steering wheel positioned for easy engagement by an individual seated on the vehicle seat. Typically, all terrain vehicles include some sort of storage capacity. That is, often molded plastic containers are tied or bolted to the vehicle adjacent or at the rear of the seat for the vehicle. The containers or cargo bags associated with such all terrain vehicles generally are a single large cargo bag or container. Typically, they are not insulated. Typically, they are bulky and thus difficult to maneuver. Typically, they may include multiple compartments.

Thus, there has developed a need and desire for alternate designs for ATV containers or cargo bags.

### SUMMARY OF THE INVENTION

Briefly, the present invention comprises a multi-section, all terrain vehicle luggage or cargo bag assembly or construction including a central section and first and second lateral side sections which are detachable from the central section. The lateral side sections typically include a longitudinal dimension which exceeds that of the central section yet are foldable and can be stored within the central section for packaging and shipment. The central section includes a generally rectangular parallelepiped enclosure with a top flap to provide access to the enclosure and a front flap which fits over a front wall panel and provides a backrest for an individual which has attached the all terrain luggage assembly to their vehicle. The lateral side sections of the assembly are attached to the central section by means of straps which fit through loops provided on the side sections. The straps at the front and back of the central section thus enable combining of multiple sections to provide improved storage capacity for an all terrain vehicle and easy removal of the separate sections. Various types of interior features are provided for the sections. For example, the central section may have rigid or semi-rigid wall panels and may be insulated for storage of food. It may also include a container with a drain tube that extends through an opening in the bag.

As a further feature of the invention, the central section or middle cargo bag may include a cushion seat which folds between a generally horizontal position that may fit over the seat of an all terrain vehicle and a folded position vertically against the side of the central cargo bag or central section. Storage straps retain the cushion in the stored position and may be released to permit folding of the cushion to the useful position as a seat cushion.

Thus, it is an object of the invention to provide an improved all terrain vehicle multi-sectioned luggage or cargo bag assembly.

Another object of the invention is to provide a multiple section, cargo bag assembly for an all terrain vehicle which is rugged, easy to assemble and disassemble, inexpensive and capable of storing multiple types of materials and items.

Yet a further object of the invention is to provide a multi-sectioned all terrain vehicle luggage assembly including first and second lateral side container sections which may be attached or detached to a central container section wherein the central container section may be utilized as a back support in combination with the seat of an all terrain vehicle.

These and other objects, advantages and features of the invention will be set forth in a detailed description which follows.

### BRIEF DESCRIPTION OF THE DRAWING

In the detailed description which follows, reference will be made to the drawing comprised of the following figures:

FIG. 1 is an isometric view of an embodiment of the luggage or cargo bag assembly of the invention in a fully assembled condition and positioned in combination with the seat of a typical all terrain vehicle;

FIG. 2 is the luggage assembly or cargo bag assembly of the embodiment of FIG. 1 in an isometric view depicting the manner of disassembly of the separate sections of the assembly;

FIG. 3 is an isometric view showing a further step in the disassembly of the embodiment of FIG. 1;

FIG. 4 is a further isometric view illustrating the disassembly and detachment of the separate container sections associated with the embodiment of FIG. 1;

FIG. 5 further illustrates in an isometric view the features associated with the disassembly of the cargo bag luggage assembly of the embodiment of FIG. 1;

FIG. 6 is an isometric view of the assembly of the embodiment of FIG. 1 as viewed from the back side and the underside thereof;

FIG. 7 is an exploded isometric view illustrating the three separate sections of the cargo bag assembly of FIG. 1 as viewed from the back side and underside thereof;

FIG. 8 is an exploded isometric view of the central section of the cargo bag assembly of the embodiment of FIG. 1 illustrating the manner of placement of a container with a drain tube therein;

FIG. 9 is a bottom or underside isometric view of the central section of FIG. 8 wherein the container and drain tube depicted in FIG. 8 have been fully inserted and positioned within the central section of the assembly;

FIG. 10 is an exploded isometric view of the central section of the luggage assembly of the embodiment of FIG. 1 wherein alternative luggage or item inserts have been depicted as being positionable within the central section;

FIGS. 11, 12, 13, and 14 represent a sequence of isometric views illustrating the manner of assembly and disassembly of the inserts depicted in FIG. 10;

FIG. 15 is a further isometric view of the inserts depicted in FIG. 10 as viewed from the underside thereof,

FIG. 16 is an isometric view of the central section of the luggage assembly of the embodiment of FIG. 1 wherein the inserts of the type depicted in FIG. 15 have been positioned therein;

FIG. 17 is an isometric view of an alternative embodiment of a central section or central cargo bag or container which employs a seat cushion that is foldable between a generally horizontal, seating position and a vertical storage position along a lateral side of the central cargo bag;

FIG. 18 is an isometric view of the central cargo bag or section of FIG. 17 depicting the manner by which the seat cushion is retained in a vertical position held against the side of the central section;

FIG. 19 is an isometric view of the cargo bag of FIG. 18 illustrating movement or transfer of the seat cushion of the central section of FIG. 18 to the horizontal position;

FIG. 20 is a bottom, isometric view of the configuration of FIG. 19;

FIG. 21 is an isometric view illustrating the back support cushion incorporated in the central section or central cargo bag that covers the straps utilized to fasten the central cargo bag to lateral side or left hand and right hand side cargo bags;

FIG. 22 is an exploded isometric view of a central cargo bag and left hand and right hand cargo bags which may be attached thereto;

FIG. 23 is a bottom isometric view of the combination of FIG. 22;

FIG. 24 is an exploded isometric view illustrating the manner in which the cargo bags of FIG. 22 may be interconnected;

FIG. 25 is an isometric view illustrating the connection of the component sections comprising the cargo bag assembly depicted in FIG. 24; and

FIG. 26 is a bottom isometric view of the assembly of FIG. 25.

### DESCRIPTION OF PREFERRED EMBODIMENTS

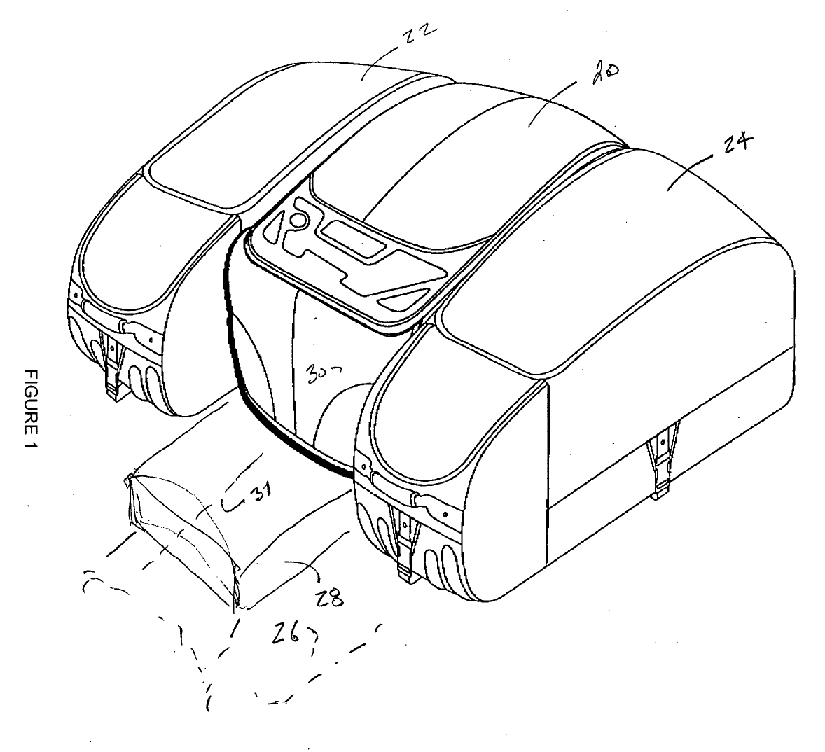

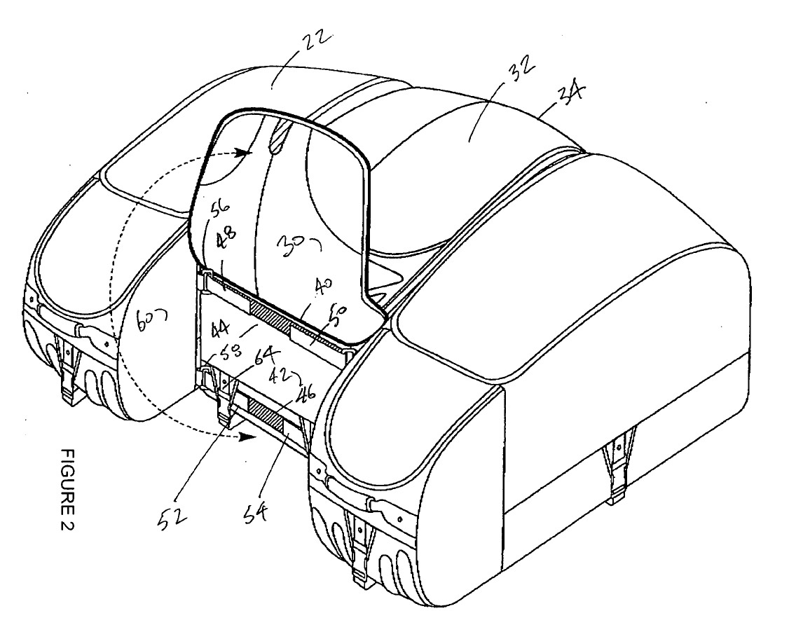

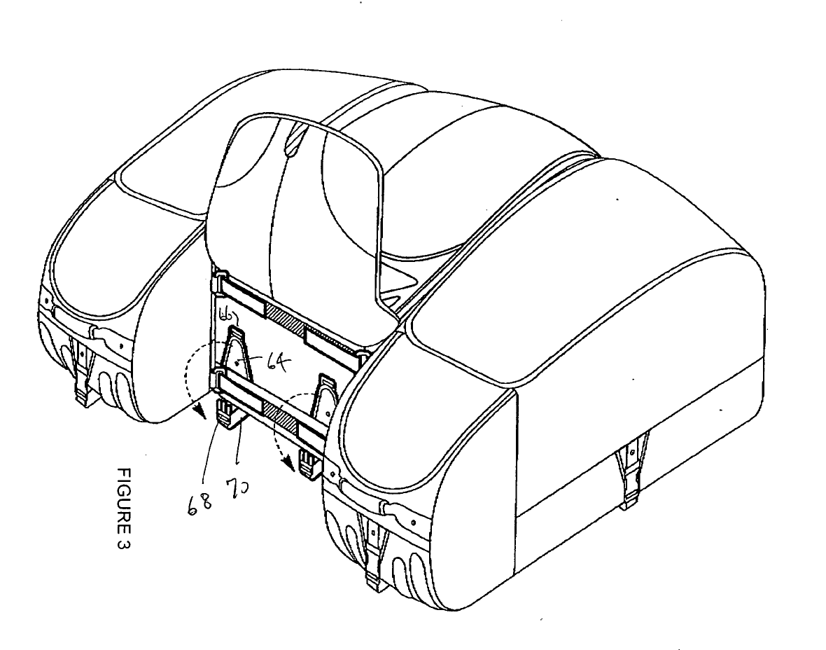

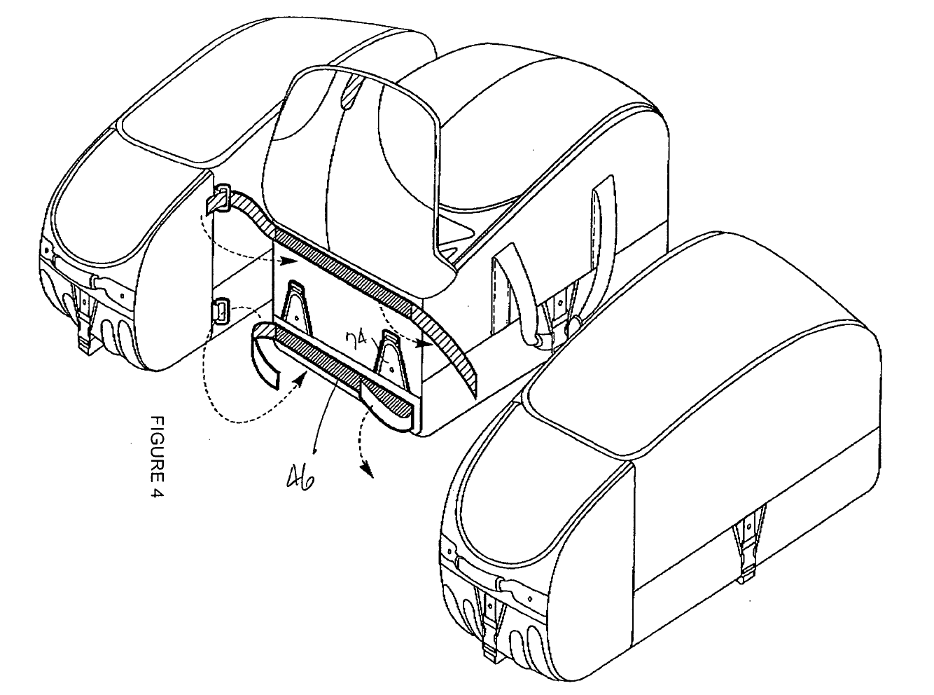

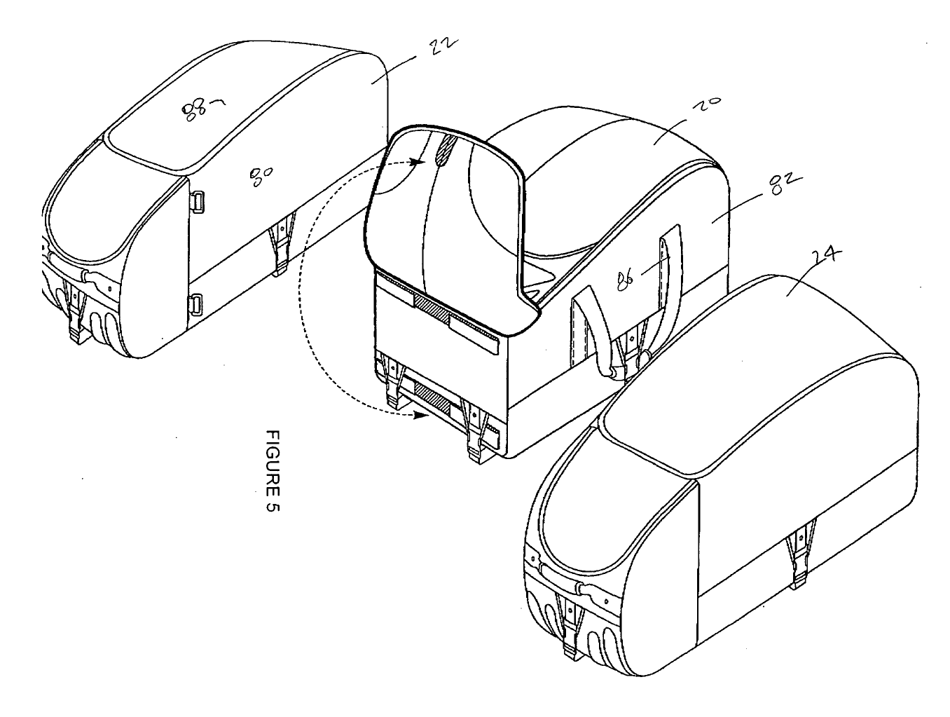

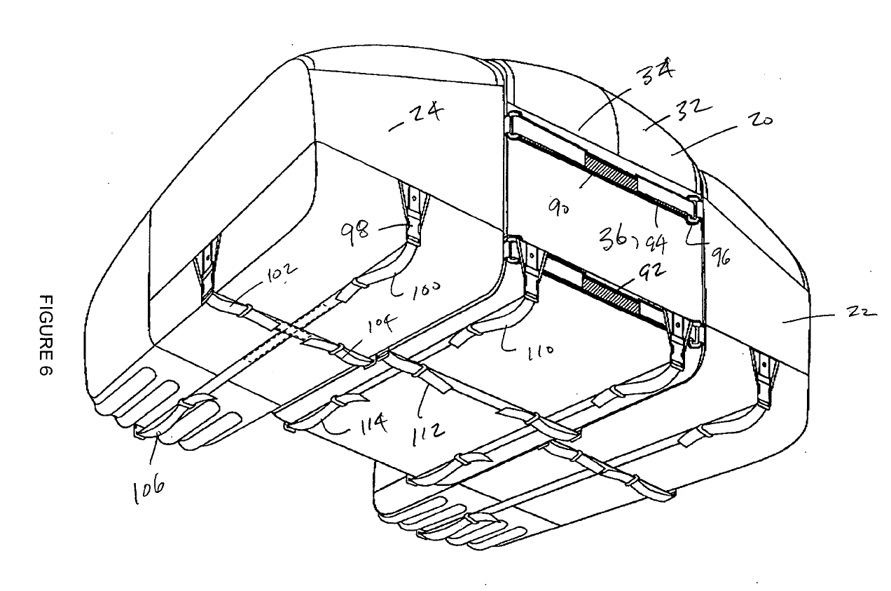

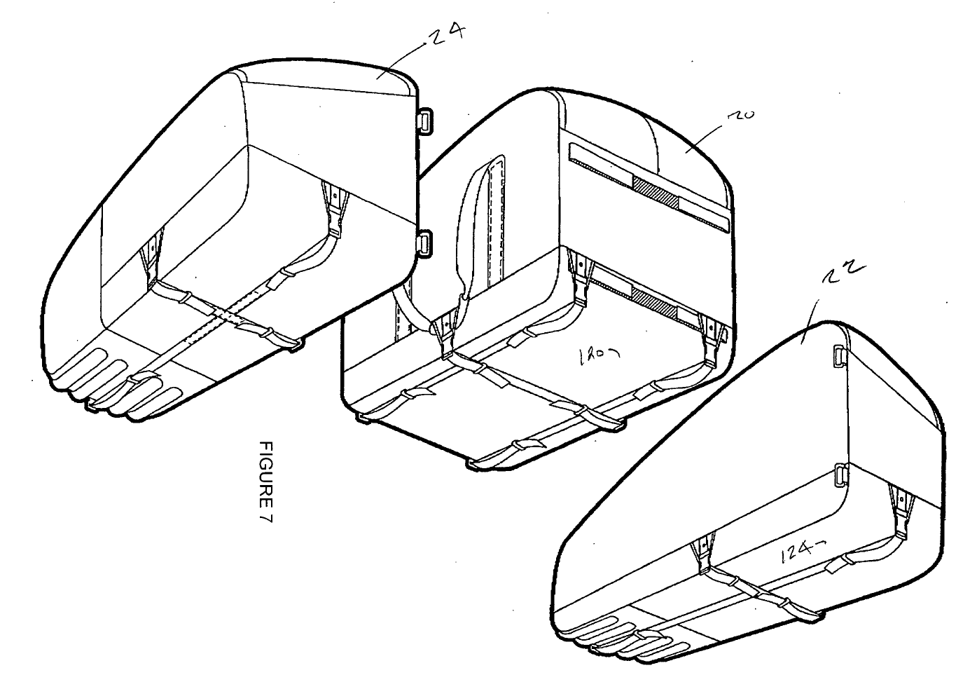

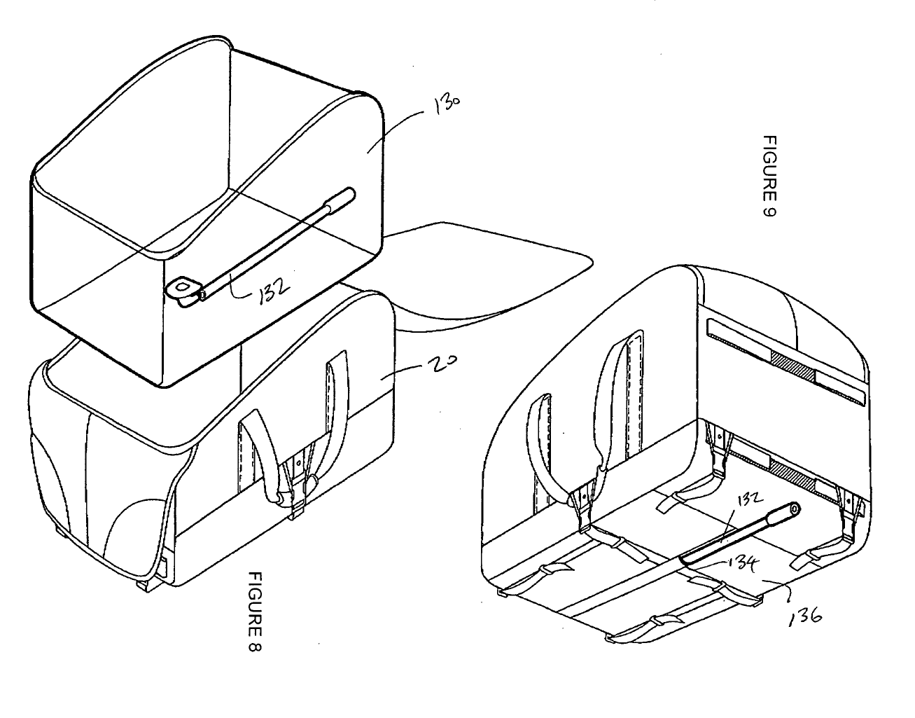

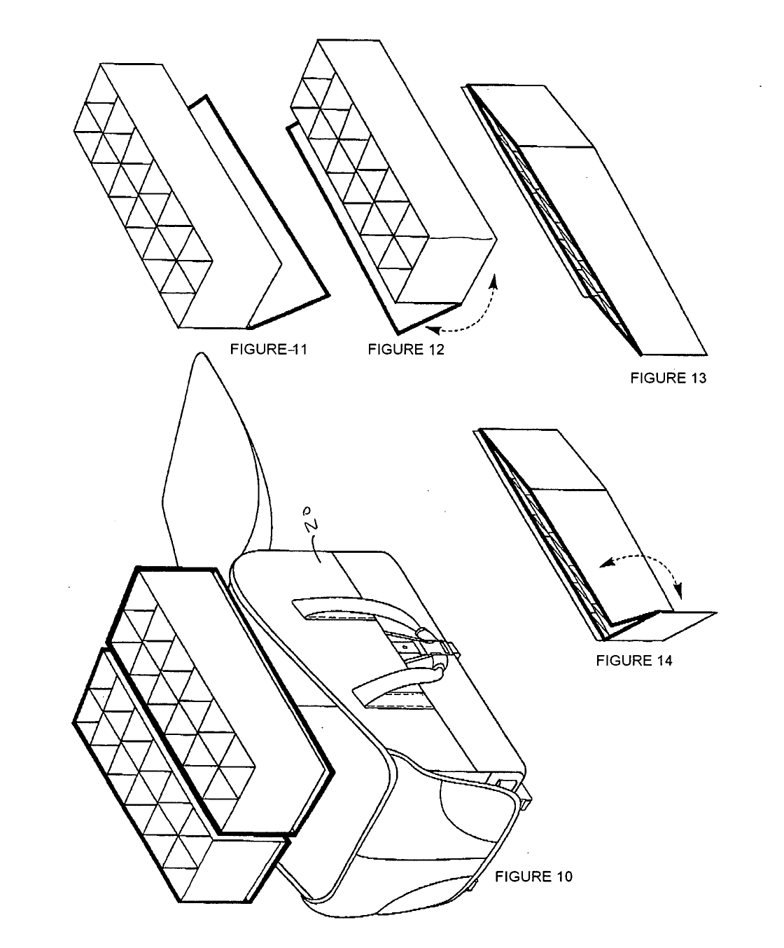

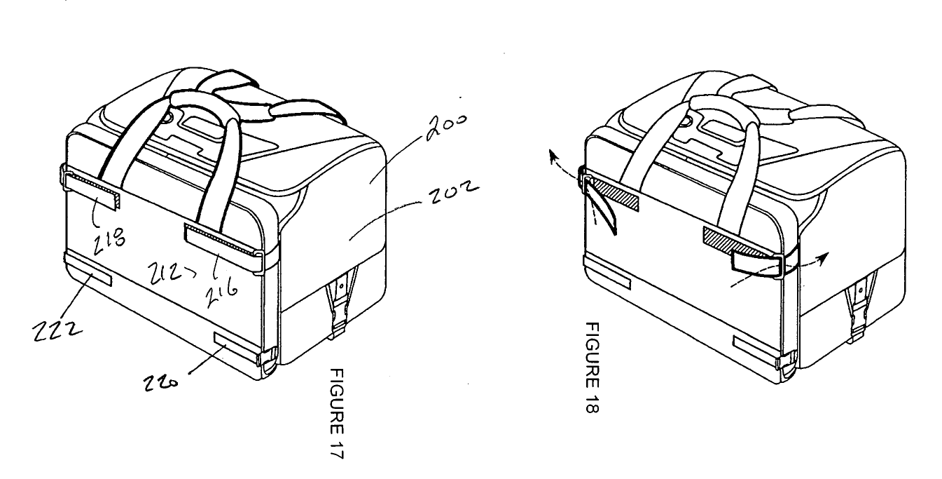

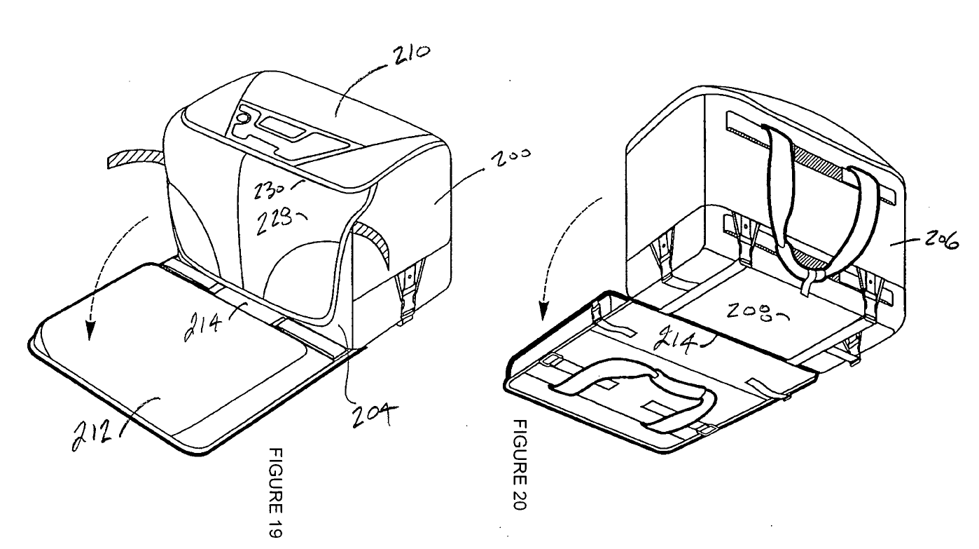

An embodiment of the invention is depicted in FIGS. 1-7. FIGS. 8-16 illustrate additional features associated, in particular, with a central section or central cargo bag container associated with the embodiment of the invention, for example, as depicted in FIGS. 1-7. The additional features depicted in FIGS. 8-16, however, are not a limiting set of features for the invention, but merely constitute additional inclusive features which may be incorporated to facilitate use of the cargo bag construction as a multi-component or multipart or multi-section cargo bag assembly.

Referring first therefore to FIGS. 1-7, the cargo bag assembly of the embodiment depicted is comprised of a central section or central cargo bag 20, a first lateral side section or right side section or right side cargo bag 22 and a second lateral side section or left side cargo bag 24. The cargo bags 20, 22 and 24 are separable. In the embodiment depicted, all three cargo bags may be positioned on an all terrain vehicle, for example, represented in phantom as vehicle 26 in FIG. 1. Typically, the cargo bag assembly comprised of the three sections 20, 22 and 24 is located at the backside of the seat 28 of an all terrain vehicle 26 and positioned so that the longitudinal axis of the central section or center section 20 is aligned with the longitudinal center axis 31 of the all terrain vehicle 26.

Attention is first directed to the center or central section 20 or central cargo bag 20. In a preferred embodiment, the central section 20 includes a top cover flap 32 attached to a back side 36 of the central section. A forward cushion flap 30 is hinged about a front edge 40 of the forward side 42 of the central luggage section 20. The front side 42 includes an upper strap 44 and a lower strap 46. The straps 44 and 46 have opposite ends 48, 50, 52 and 54 which are flexible and may be fitted through connection rings such as ring 56 and ring 58 fastened to a first lateral side 60 of left lateral section 22. This is depicted, for example, in FIG. 2. The straps, such as strap 48, include a hook and loop fastener (Velcro fastener) in a preferred embodiment so that the straps such as strap 48 may be fitted through ring 56 and fastened to tightly engage and hold lateral side walls 60 against a lateral side wall of the central section 20. Each of the straps 44 and 46 include such connection arrangements which enable attachment of the left and right lateral side sections 22 and 24 to the central section 20 of the luggage assembly. Note that the front cover cushion flap 30 is designed to be fitted over the straps 44 and 48 in order to protect the straps and also to provide a backside cushion for a person seated in the seat of the all terrain vehicle upon which the luggage assembly has been situated.

The straps and more particularly the lower straps 52 and 54 of the lower band 46 are covered by a hinged connection buckle element 64 as shown in FIG. 2. This cover flap 64 is also depicted in FIG. 3 and includes a buckle element 66 connectable to a second buckle element 68 associated with a connection strap 70 which is used to attach the central section 20 to the all terrain vehicle. In similar fashion as depicted in FIGS. 3 and 4, a second flap 74 covers the lower strap 46 and is designed to be associated with a compatible buckle element.

FIGS. 3, 4 and 5 thus depict the manner in which the central section 20 may be attached to or detached from the lateral side sections 22 and 24. Thus, for example, section 22 includes a lateral side panel 80 which is positioned in opposed relation to a side of the central section 20. Similarly, the lateral side section 24 includes a sidewall panel that may be positioned against lateral side 82 of the central section 20. The straps, as previously described, may then be attached or released as the case may be, to attach the side sections 22 and 24 to the central section 20.

The longitudinal dimension (e.g., along axis 31) of the central section 20 is desirably lesser than that of the side sections 22 and 24. Thus, the flap 30 can serve as a back cushion and the forward ends of the lateral side sections 22 and 24 can serve as arm rests for the driver of the all terrain vehicle having the assembly positioned thereon.

The various sections, 20, 22 and 24 may be totally disassembled or partially assembled in any array desired. When disassembled, the central section 20 includes carry straps such as the strap 86 which facilitate transport of the central section 20. The lateral side sections, such as section 22, may include a removable top flap such as the flap 88 for access to the interior thereof. As depicted in FIG. 6 the back wall 36 of the central section 20 includes upper strap 90 and lower strap 92 having strap ends, for example, strap end 94 which fits through a ring 96 associated with a side section 22. In this manner, the straps 90 and 92 in combination with the straps 44 and 46 function to maintain the attachment of the assembly sections or may be utilized to release those sections. Each of the sections further include auxiliary buckles such as the buckle 98 for the lateral side section 24 which connects with a strap 100 that may be utilized to attach the lateral side section 24 to the all terrain vehicle 26. Similar additional straps such as straps 102, 104 and 106 are provided in association with each of the lateral sides of the section 24.

The central section 20 includes similar strap assemblies such as strap assembly 110 and strap assembly 112 as well as strap assembly 114. The number and position of the various strap assemblies is dependent in part upon the construction of the all terrain vehicle and the connection points for such straps. The array of the described embodiment which positions strap connections at the midpoints of the various sections of the separate elements of the assembly typically will generally suffice for the attachment of the cargo bag assembly to an all terrain vehicle.

FIG. 7 illustrates the cargo bag assembly from the backside wherein the separate sections 20, 22 and 24 have been separated from one another. It is to be noted that the side or lateral sections 22 and 24 may be comprised of flexible material such as canvas, plastic or other similar material and thus folded and placed within the central section 20 for purposes of packaging and shipment. The central section 20 may include a lower side molded pan, for example pan 120, which will maintain the general configuration of the central section. Alternatively, or in addition, a generally rigid sided box shaped container, such as container 130 in FIG. 8, may be placed in section 20 to provide a generally rigid sided or form maintained container which renders the total assembly capable of retaining the configuration depicted in FIG. 1 even when the separate sections 20, 22, 24 do not contain articles. The remaining component parts or sections 22, 24 may then be made from a flexible material as previously described. However, in a preferred embodiment the central section will include reinforcing elements such as bamboo strips, wire inserts or polyethylene board inserts positioned between layers of fabric forming the lateral sides and front and back side of the central section 20. Similarly, the lateral side sections 22 and 24 may include molded plastic component parts, in whole or in part, forming the bottom section, for example, of section 24. Thus, there are a myriad of ways in which the separate sections comprising the combination may be fabricated to provide a luggage container or multiple separate luggage containers.

FIGS. 8 and 9 illustrate a construction wherein an insertable premolded pan or tray 130 with a drain tube 132 may be inserted into a soft side central section 20. In this embodiment, the drain tube 132 will fit through an opening 134 in bottom side 136 of the central section 20. The tray 130 thus provides a means to maintain the form and shape of the central section. Other alternative constructions are illustrated in the remaining figures. The tube 132 permits draining of water in the event the container 130 is filled with ice and is used as a cooler.

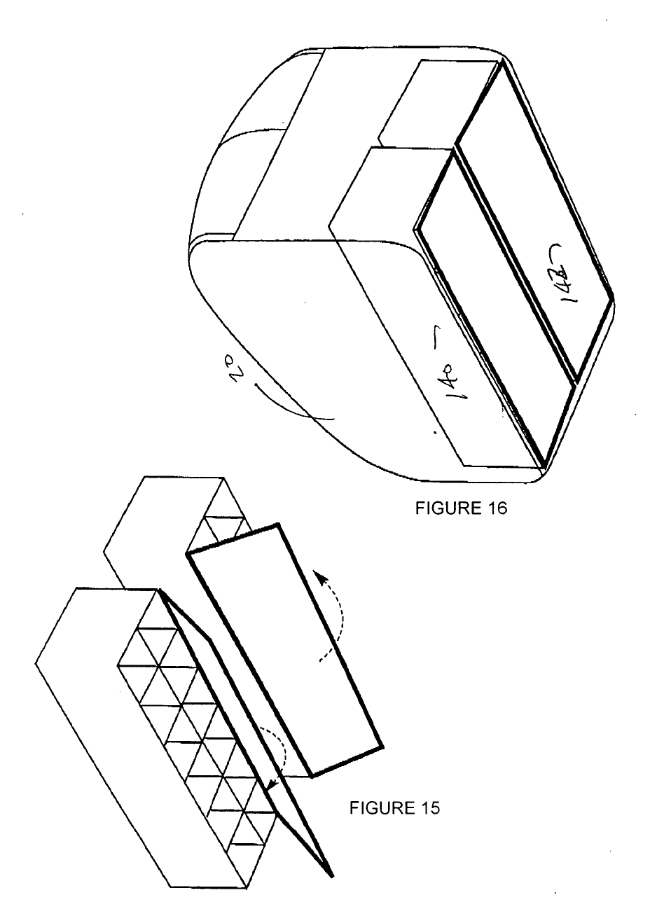

Thus, referring to FIGS. 10-16, it will be noted that a foldable rigid sided carton, for example, of the type which would retain and hold canned goods, drinks or the like, may be positioned within the central container 20. Thus, a multi-sided foldable drink container in the form of a multiple sided rigid hinged element as depicted in FIGS. 11-15 can be folded to a flat condition as illustrated in FIG. 13 or alternatively to the open and unfolded condition of FIG. 15. The assembled trays, for example, of FIG. 15; namely, the trays 140 and 142 may then be inserted into the interior of the central section 20 to provide form and shape to that central section as well as providing a means for organizing storage.

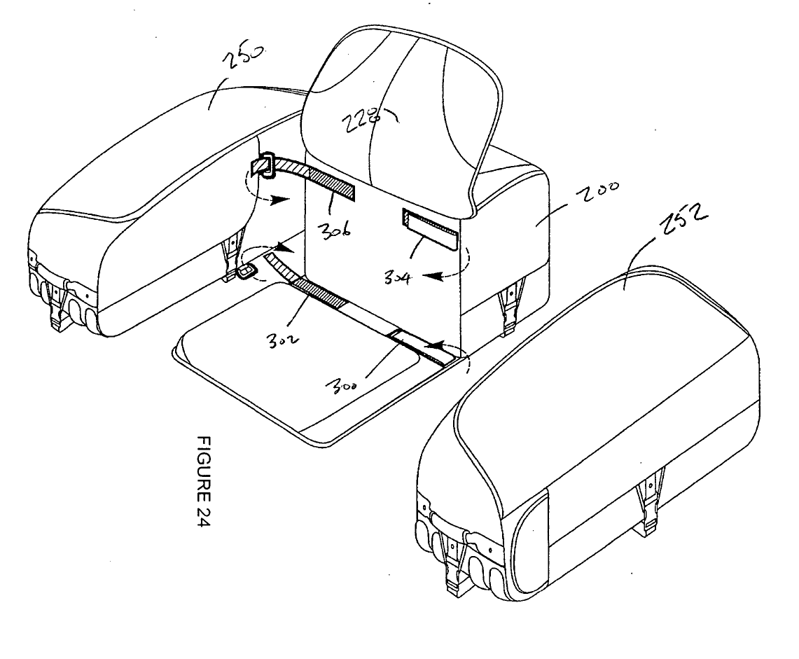

FIGS. 17-26 illustrate an alternative embodiment of the invention. Again, the assembly of cargo bags is typically comprised of three elements; namely, a central section 200 as depicted in FIGS. 17-21 and lateral side or right hand and left hand side sections or cargo bags as depicted in FIGS. 22-26 in combination with a central section.

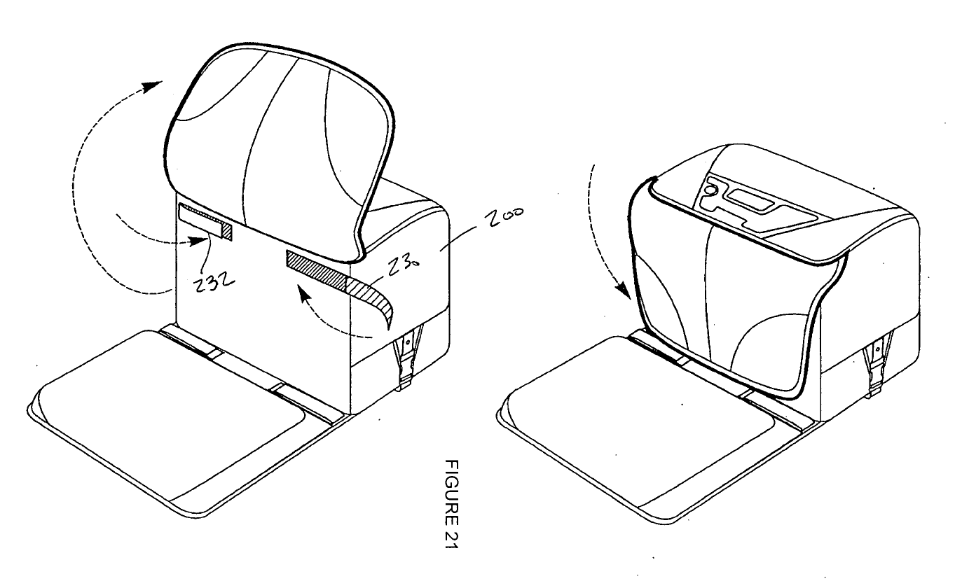

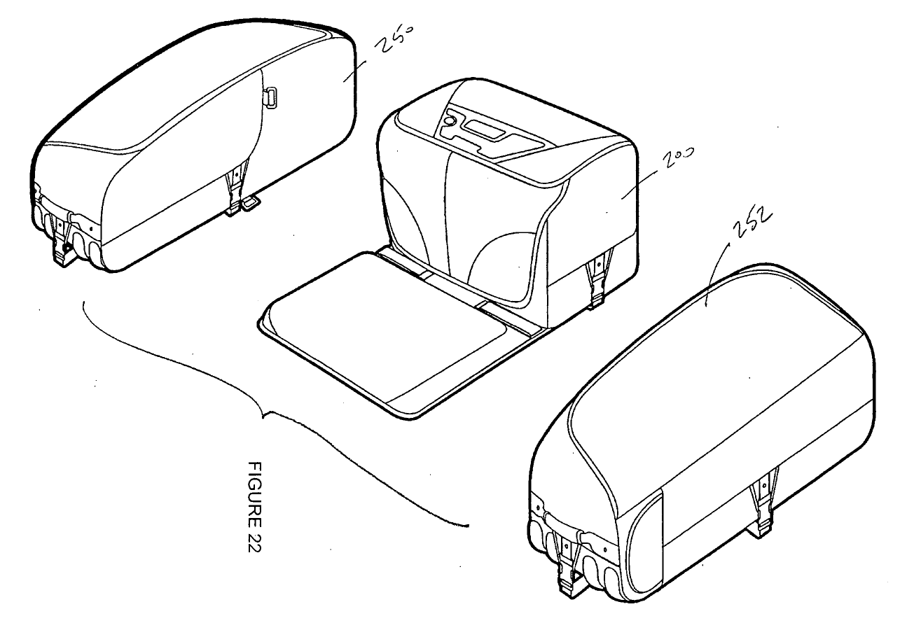

Therefore, referring to FIGS. 17-21, a central section 200 is in the form of a generally parallelepiped bag having lateral sides, such as lateral side 202, a front side 204, a back side 206, a bottom side 208 and a cover 210 which comprises a top side. Second lateral side (not shown) is provided opposite the lateral side 202. The central section or central cargo bag 200 further includes a seat cushion 212 hinged about a flexible joint 214 along the bottom edge of the front wall 204 generally where it joins the bottom wall 208. The seat cushion 212 typically has an outline with the peripheral dimension of the lateral side wall 204. It folds between the position depicted, for example, in FIGS. 17 and 18 to the position shown, for example, in FIGS. 19 and 20. Thus, in FIGS. 17 and 18 the seat cushion 212 is fastened against the lateral side 204 and retained thereby by straps such as straps 216 and 218. Release of the straps 216 and 218 as well as additional auxiliary straps 220 and 222 enable folding of the seat cushion 212 from a generally vertical position as illustrated, for example, in FIGS. 17 and 18 to a generally horizontal position such as illustrated in FIGS. 19 and 20.

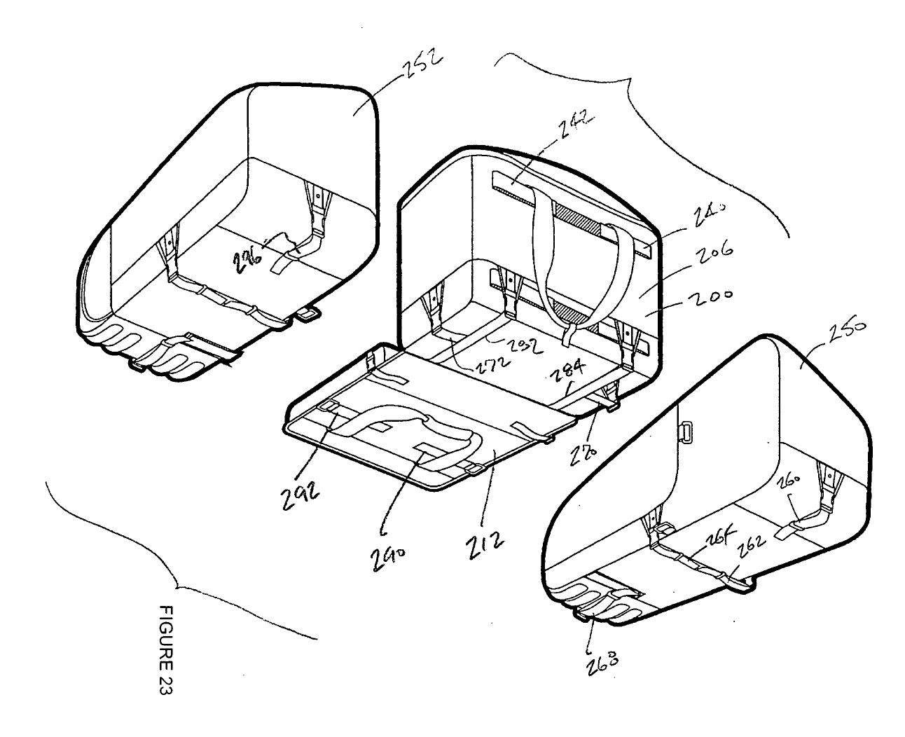

A front flap 228 is hinged along its top edge 230 to the top of the central section or central cargo bag 200. The front flap 228 is substantially identical or similar to the flap previously described with respect to the embodiment depicted in FIGS. 1-10. The flap 228, as depicted in FIG. 21, covers straps 230 and 232 which serve to connect the central cargo bag or central section 200 to the lateral side bags described hereinafter.

FIGS. 22-26 depict in greater detail the manner in which the various sections or cargo bag sections may be joined one to the other. Generally the method of joining them together is as previously described with respect to the embodiment of FIGS. 1-10. That is, straps associated with the back side 206 of the central section 200, such as straps 240 and 242, are provided to connect through ringlets or rings associated with a right hand auxiliary cargo bag 250 and a left hand auxiliary cargo bag 252, respectively. Similar additional straps of the type previously described with respect to the first embodiment of FIGS. 1-10 are provided to enable attachment of the lateral side cargo bags or sections 250 and 252 to the central cargo bag or cargo section 200. Each of the cargo bags, such as cargo section 200 and lateral side sections 250 and 252, include an array of straps or independent attachment of those bags to the all terrain vehicle. For example, lateral side section 250 includes straps 260, 262, 264 and 268 which serve to attach that particular cargo bag to an all terrain vehicle. Similarly, the central cargo section 200.includes straps 270 and 272 as well as straps 280 and 282 which may be utilized for such attachment. Additionally, the underside or outside surface of the cushion 212 includes a number of straps such as straps 290 and 292 which serve to attach the cushion 212 to the seat or to other parts of the all terrain vehicle. Similarly, the other or left hand section or cargo bag 252 includes a plurality of straps. Strap 296 is an exemplary strap. Other straps are depicted in the drawings.

Thus, referring to FIG. 22, there is depicted an exploded isometric view of the various cargo sections 200, 250 and 252 prior to their joinder. FIG. 23 discloses the same array of component parts including the open seat cushion 212 as viewed from the underside with respect to FIG. 22.

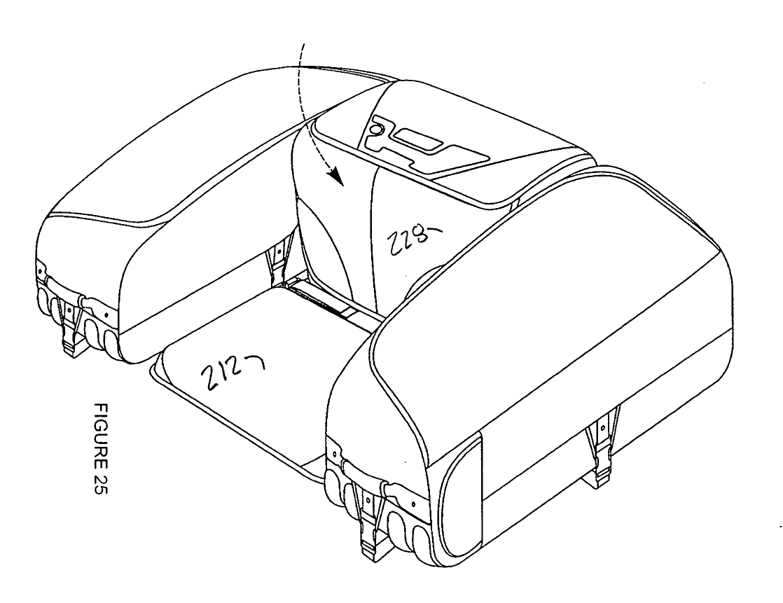

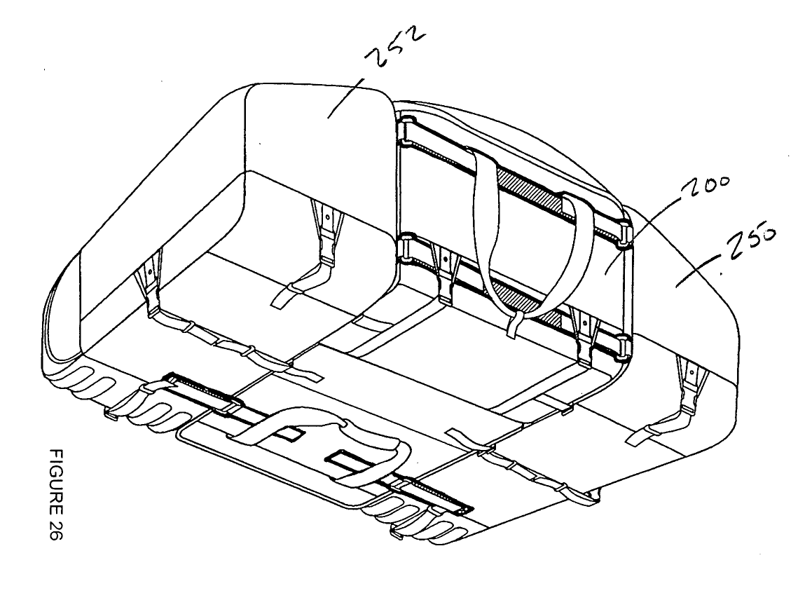

FIG. 24 illustrates the manner in which the various sections 200, 250 and 252 are interconnected by means of various straps such as straps using hook and eye fasteners; namely, straps 300, 302, 304 and 306. FIG. 25 illustrates the connection of all the strap components and sections 200, 250 and 252. It will be noted that the flap 228 is raised in FIG. 24, but has been lowered in FIG. 25 to cover the various connecting straps. The seat section 212 is held in position by straps previously described. The ultimate combination then as is depicted from the underside thereof and in an assembled condition in FIG. 26. Each of the separate cargo bag sections 200, 250 and 252 thus may be independently attached to the all terrain vehicle. The central section 200 may be attached to one or both of the lateral side sections. The sections may thus be independently attached or detached to the all terrain vehicle. The seat 212 may be folded or unfolded, depending upon the desires of the user of the embodiment depicted in FIG. 26, for example.

With the embodiments of the present invention, the size and shape of each of the separate sections may be modified for special needs. Each of the sections may be insulated or uninsulated. If one of the sections becomes damaged, it may be replaced. Various types of inserts may be included in any one or all of the sections. For example, as depicted in FIGS. 11-15 drink and bottle holders may be inserted to provide the multiple functions of providing an insulating feature, a form or shape retention feature for the bag and a feature enabling removal or replacement of the drink and bottle holders should they become damaged.

The embodiments described utilize straps that employ hook and loop fastening features in combination with the rings or loops to hold the various container sections, containers or cargo bags together. Various other attachment devices are considered to be within the scope of the claims. Additionally, it is noted that each of the sections or containers are independently attachable to the vehicle, such as an all terrain vehicle. Thus, one or more of the containers may be removed or placed on a vehicle. The fact that the combination of various cargo containers may be positioned on a vehicle provides other benefits. Each of the cargo containers may be especially adapted for a particular use or may be especially constructed of different materials thereby facilitating different utility. The separate containers may be individually decorated, color coded or otherwise constructed. In other words, the left and right hand cargo containers or sections need not be identical. The size and shape of the various cargo containers can be altered or amended. However, typically the lateral side cargo bags or containers have a larger or greater longitudinal dimension so that they may provide lateral support to a rider on an all terrain vehicle whereas the back flap and support seat associated with the central cargo section provide the aspect of comfort with respect to the use on an all terrain vehicle.

With the construction of the invention as depicted in the embodiments discussed, therefore, multiple benefits accrue. Various changes may be made, however, without departing from the spirit and scope of the invention. Thus, the invention is to be limited only by the following claims and equivalents thereof.

What is claimed is:

1. A multiple section all terrain vehicle luggage assembly comprising, in combination:
a generally rectangular parallelepiped central container section having a forward side panel, a bottom side panel, a back side panel, a top side panel, a first lateral side panel and a second lateral side panel spaced from the first lateral side panel to form an enclosure, said top side panel comprising a hinged flap for enclosing the container, the front side panel and backside panel including laterally projecting straps extendable laterally from the central container section, said front side panel including a cushion flap hinged to the top of the front side panel and foldable between a position covering the straps on the front side panel and a position exposing the straps on the front side panel;
a first lateral side, generally rectangular parallelepiped container section attachable to the central container section, said side container section including a generally planar side panel for placement in opposed relation to the first lateral side panel of the central container section, said side container section side panel including strap receiving connectors positioned for receipt of a strap extending from the front side panel and from the back side panel of the central container section to thereby retain the lateral side container section juxtaposed against the central container section in combination, said cushion flap foldable to cover the straps extending from the front side panel.

2. The assembly of claim 1 including a second lateral side container section, having a lateral side wall for placement in opposed relation to the second lateral side of the central container section and including strap receiving connectors on said second container lateral side wall for receipt of connecting straps extending from the central container section front and back side panels.

3. The assembly of claim 1 including an array of connecting straps on the bottom side panel of said central container.

4. The assembly of claim 1 wherein the lateral side container includes a bottom side panel with an array of connecting straps.

5. The assembly of claim 1 including an insertable storage assembly in the central container section.

6. The assembly of claim 1 including a drain tube for the enclosure through the bottom side panel of the central container section.

7. The assembly of claim 1 wherein the bottom side panel of the central container section is generally rigid.

8. The assembly of claim 2 wherein the lateral side panel includes a generally rigid bottom side panel.

9. The assembly of container sections of claim 1 wherein the central container section includes a maximum longitudinal dimension between the front panel and back panel and wherein the lateral side panels of the first and second lateral side container sections extend forwardly of the front side panel of the central container section.

10. The assembly of claim 1 wherein the central container section includes a maximum longitudinal dimension between the front panel and back panel and wherein the lateral side panels of each lateral side container sections extend forwardly from the front side panel approximately equally.

11. The assembly of claim 1 wherein the connectors comprise ring members and one of said straps is extendable through each ring member to attach container sections together.

12. The assembly of claim 1 wherein the front side panel of the central container section is generally rigid.

13. The assembly of claim 5 wherein the insertable assembly comprises a collapsible insulating container.

14. The assembly of claim 1 wherein the flap is hinged to the front side panel and the top side panel is hinged to the back side panel.

15. The assembly of claim 1 further including a seat flap hinged to the front side panel of the central container.

16. The assembly of claim 15 wherein the seat flap is foldable between a position generally against the front side panel of the central container and a generally horizontal position extending from the front side panel.

17. The assembly of claim 1 wherein each container includes attachment devices for attachment to a vehicle.

18. The assembly of claim 2 wherein each container includes attachment devices for attachment to a vehicle.
